(19) United States
(12) Patent Application Publication
(10) Pub. No.: US 2025/0308027 A1
(43) Pub. Date: Oct. 2, 2025

(54) METHODS OF DETECTION, CLASSIFICATION, AND MOTILITY ASSESSMENT OF SPERM CELLS IN IMAGES OR VIDEOS

(71) Applicant: QART MEDICAL, Raanana (IL)

(72) Inventors: Alon SHALEV, Raanana (IL); Natan SHAKED, Raanana (IL)

(21) Appl. No.: 18/873,228

(22) PCT Filed: Jun. 26, 2023
(86) PCT No.: PCT/IL2023/050658

§ 371 Date: Dec. 9, 2024

Related U.S. Application Data
(60) Provisional application No. 63/355,637, filed on Jun. 26, 2022.
(60) Provisional application No. 63/390,824, filed on Jul. 20, 2022.

(51) Int. Cl. G06T 7/00

(52) U.S. Cl. CPC G06T 7/0016; G06T 2207/10056; G06T 2207/20081; G06T 2207/20084; G06T 2207/20182; G06T 2207/30024; G06T 2207/30241

(57) ABSTRACT

Means for rigorous quantitative assessment of sperm motility are presented, based on a number of movement and morphology parameters measured using various image processing methods. The quantitative assessment thereby achieved is objective and multidimensional, allowing for detailed and repeatable assessment of samples. Deep learning methods are also disclosed for detection and classification of sperm cells (or other types of cells or particles) using neural networks, adapted to work both in good and in poor imaging condition, such as low magnification and resolution. Specific methods for both supervised and unsupervised deep learning approaches are delineated. In a non-limiting disclosure, the methods are particularly adapted to deal with cases of azoospermia, where there is a very low number of sperm cells (most of which do not swim) and a lot of debris in the imaged field of view.

### FIELD OF THE INVENTION

The present invention relates generally to the field of automated visual inspection means for detection and classification of spermatozoa, including hardware and methodological provisions for analyses of motility.

### BACKGROUND OF THE INVENTION

Motility as such is the ability of sperm to move properly through the female reproductive tract to reach the egg. Methods for assessment of the motility of sperm generally attempt to indirectly assess the reproductive viability of the sperm population, as the sperm motility generally correlates with rates of successful fertilization. Several different instruments and methods have been developed for automated or semi-automated assessment of sperm motility, including the classic spermiogram, time-lapse photomicrography, frame-by-frame playback videomicrography, spectophotometry, stroboscopic methods, and various methods of computerized analysis.

Computerized motility analysis can provide objective measures of sperm motion characteristics taken from tracks of large numbers of sperm. Such measures include percentage of motile sperm, percentage of progressively motile sperm (i.e., above a preset cutoff for speed and curvature of movement, to correlate with the traditional manual assessment), amplitude of lateral head displacement during forward movement, and measures of linear and curvilinear velocity.

The classic spermiogram assesses the fraction of moving sperm as well as a finer-grained “motility grade” from grade A (rapid progressive-swimming forward quickly in a roughly straight line) down to grade D for non-moving sperm. Rapid progressive sperm motility generally is considered to be the most credible gauge of sperm motion for predicting the fertilizing capacity of a semen sample, albeit the ‘rapidity’ here is a subjective assessment. These assessments were traditionally made manually by a trained technician, generally using a microscope equipped with phase-contrast optics and a warming stage.

Such assessments of sperm motility generally include total sperm motility fraction (percentage of sperm that exhibit motility of any form), progressive sperm motility fraction (percentage of sperm that exhibit rapid, linear movement), and sperm velocity, on an arbitrary scale of 0 [immotile] to 4 [rapidly motile]. For example, a motility of 75/70 (4) indicates that 75% of sperm were motile and 70% of sperm were progressively motile, moving ‘rapidly’ across the microscopic field.

However these methods all suffer from various drawbacks including limited spatial and temporal resolution, the primitive assessment of movement which is generally restricted to measurement of average linear velocity (if measured at all), and requirement for various degrees of human intervention and analysis.

### SUMMARY OF THE INVENTION

The invention comprises systems and methods adapted to assess sperm motility quantitatively and repeatably, providing a number of improvements on the state of the art both in terms of the resolution of the measurements obtained, and in terms of the nature of the movement parameters that can be assessed.

In particular, the invention firstly provides means and methods for achieving super-resolution to assess position and movement at sub-pixel levels; and secondly provides for modeling the movement of motile sperm by fitting a number of movement parameters to the observed motion. This latter allows for a better characterization of the sperm movement, by introducing quantitative measures of linearity and curvature and ‘higher order’ movement, as will be discussed in the detailed description.

Further methods are disclosed for automated detection sperm cells (or other types of cells or particles) using neural networks, adapted to work both in good and in poor imaging condition, such as low magnification and resolution. Detection is a necessary first step for further automated analyses including motility assessments. For such purposes a training phase is used that can employ automatically produced training data as well as the more standard human annotated training data, and once this phase is complete the network can automatically detect sperm cells (stationary or dynamic) in a given field of view, in some cases in real time. The training phase generally may use methods such as back propagation, using a stochastic approach to train in batches.

The method is particularly adapted to deal with cases of Azoospermia, where there is a very low number of sperm cells (most of which do not swim) and a lot of debris in the imaged field of view. The method allows for automatic digital removal of much of this debris such that subsequent analysis is facilitated.

Further methods are disclosed to determine neural network latent-space or hidden features from stationary images (morphological features) and/or videos (dynamic features) for purposes of classification, as well as unsupervised methods to generate such features and allow training on unlabeled data. The use of latent-space features allow a new standardization for image and video analysis of spermatozoa, by indicating what the most important stationary and dynamic features for sperm analysis are.

Methods of the invention can be used to automatically grade the quality of a sperm cell but also automatically detect a sperm cell in an image or a video and differentiate it from debris.

The foregoing embodiments of the invention have been described and illustrated in conjunction with systems and methods thereof, which are meant to be merely illustrative, and not limiting. Furthermore, just as every particular reference may embody particular methods/systems, yet not require such, ultimately such teaching is meant for all expressions notwithstanding the use of particular embodiments.

### BRIEF DESCRIPTION OF THE DRAWINGS

Embodiments and features of the present invention are described herein in conjunction with the following drawings:

FIG. 1 shows one method for parametrization of a sperm's path.

FIG. 2 shows a plot of motility vs. beat frequency.

FIG. 3 shows a sample of spermatozoa and pipette.

FIG. 4 shows one possible implementation of a CNN and RNN adapted for video sequence motion prediction.

### DETAILED DESCRIPTION OF PREFERRED EMBODIMENTS

The present invention will be understood from the following detailed description of preferred embodiments, which are meant to be descriptive yet not limiting. For the sake of brevity, some well-known features, methods, systems, procedures, components, circuits, and so on, are not described in detail.

### Hardware Setup

The invention may use a standard biological cell imaging setup (which may for instance include one or more phase-contrast or other types of microscopes, sample stage with x-y and possibly z-axis control, an optional heated sample bed, and video cameras). In principle, cellphones with suitable magnification means may be used instead of dedicated imaging setups. Alternatively, images or videos taken using such methods may be analyzed by software and other means of the invention.

### Superpixel Resolution

The invention provides means and methods for achieving super-resolution to assess position and movement at sub-pixel level, allowing for subsequent image processing steps described below to be carried out with higher accuracy than would otherwise be possible.

The invention uses methods for super-resolution, which are generally techniques using multiple images of lower resolution together to achieve resolution higher than that of the camera hardware. This may be achieved by one or more means. Below we mention methods to boost the number of images acquired in a given amount of time, then discuss some methods for combining information obtained from these images to achieve superpixel resolution.

### Sample Stage Motion

To deal with motion of the sample stage (for instance when the stage is being moved to analyze a new area of the sample), collective motion-cancellation may be used. This may be done using a continuous estimation of the vector-of-motion of the entire FOV. Relative to this motion, the respective motion-vectors of individually-tracked moving objects may be subtracted to find the ‘absolute motion’ of these objects. This feature allows continuous tracking of sperm cells, and continuous accurate motion assessment, even while an operator is moving the microscope stage. The vector-of-motion may be calculated as the highest amplitude percentile vector-of-motion detected in the sampling-space within the FOV, wherein, the FOV is divided to equal rectangles of, e.g. 1/10 of the width by 1/10 length of the FOV (or any other ratio of the FOV to the size of each individual cell). It is also within provision of the invention to make use of a fixed pattern (e.g. a grid, ruler, or other easily-identified and-tracked object) on the sample dish, on the basis of which, the FOV's basal vector-of-motion is estimated. Such subtraction should be conditioned upon minimal threshold energy to the “frequent” average motion vector percentile.

An alternative implementation is to average the motion of tracked objects, and from this value, to calculate the average motion of the slide, in the case that such motion is found to have enough energy (as measured for instance in terms of kinetic energy averaged over some time frame). This approach may have limitations, in case the motion of sperm cell is spatially constrained (e.g. by the edge of the hydrous drop, in which the sperm cells are swimming). Moreover, such calculation may also be biased in case there is a prominent effect of chemotaxis, or thermotaxis, i.e., in case the is a chemical, or thermal stimuli for the individual sperm cells, toward which source they are preferentially swim, in which case, the vector-of-motion of the FOV may not be correctly estimated. These cases may have extra utility, however, since chemotaxis and/or thermotaxis may be relevant parameters for healthy sperm. Thus it is within provision of the invention to provide chemical and/or thermal gradients in the sample dish and observe the sperm motion under influence of these gradients. By observing motions both with and without gradients, the preferential motion under gradient may be ascertained. Thus the sample dish may be initially neutral, the motions observed, and then a thermal or chemical gradient introduced, and the new motion observed, allowing the differences and thus contribution of the gradients to be found.

A further method is to employ an x-y (and possibly z-) stage that is either motorized, provided with shaft encoder, linear encoder or other means for position readout, or both. In this case the stage motion is known from either the shaft encoders, motor actuation, or both, and can thus be accounted for in the algorithms mentioned above. In the case of superpixel resolution the measured/known motion may be used as initial input to an algorithm adapted to further refine these initial estimates of stage motion. Further methods we consider for this purpose are the eight-parameter projective motion model, block matching, and Horn-Schunck optical flow estimation (see Journal of Visual Communication and Image Representation Volume 9, Issue 1, March 1998, Pages 38-50 “Subpixel Motion Estimation for Super-Resolution Image Sequence Enhancement”).

### Registration and Background Removal

Methods of registration and/or background removal may be employed as a first step before superpixel and other subsequent operations.

If the camera is disposed largely fixed, then background removal of various types may be implemented to increase resolution as well. The background image may be assessed by use of a moving average over history, or may for instance utilize the ‘median image’ where the background image is calculated for each pixel as the median value (not the mean) for that pixel over some history. This will tend to more completely remove motion artifacts due (for instance) to motion of sperm in the image than taking the mean image does. This background, however it may be calculated, can then be subtracted from a given frame to more clearly show moving objects only. Since not all elements of a moving object necessarily move from frame to frame (or equivalently, if movement occurs between regions having the same pixel value), moving pixels may be marked not just from frame to frame but for instance any pixel that has moved within the last N frames may be marked as showing movement. Segmentation methods may be employed to identify the entirety of the moving objects (in this case usually motile sperm), for example based on conditional random fields, neural networks, or other segmentation methods.

If the camera is not fixed with respect to the sample stage, then various methods of image registration may be employed to register successive images and bring about a situation where successive frames ‘match’ in terms of background, largely eliminating the effects of relative movement between camera and sample stage. Registration may be accomplished for instance by using image features such as SURF or SIFT features (as will be familiar to those versed in the field of computer vision) in two frames to be registered, and from these features, calculation of a homography to transform coordinate systems between images using features common to both frames.

### Filtering Irrelevant Objects

To avoid tracking objects that appear to move in the incoming frames but which are irrelevant to the measurements being made, several techniques may be used.

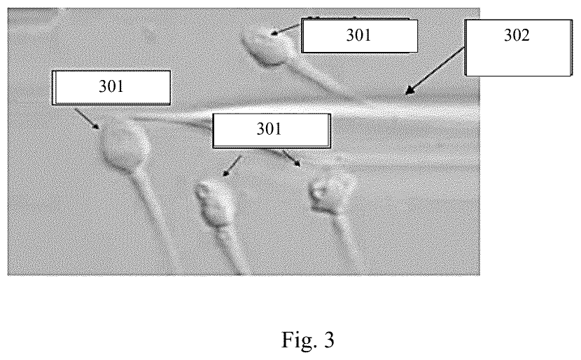

Elimination of objects according to their size, depending on magnification scale, may be used. For example, the micro-pipette, which has a surface area that is substantially larger than a typical sperm cell's head, can be eliminated from the list of tracked-moving-objects. This is in order to prevent “wasting” expensive computational resources on processing motion of irrelevant objects. Thus segmentation techniques (e.g. based on conditional random fields, neural networks, or other segmentation means) may be used to segment out such objects and remove them from the frames in which they appear. An example of an image including both spermatozoa and pipette is shown in FIG. 3; in this case the far-larger pipette may be eliminated from further consideration as described above. In FIG. 3 sperm cells 301 are seen as well as a capillary tube head 302.

Elimination of objects according to their morphology may also be used. For example, tissue debris, even in case they are in the same scale as sperm cells, may usefully be removed. This may be done with morphology-based means such as curvature- and moment-based measurements, or neural network methods—since they don't have “tails” (like a mature sperm cell is expected to have) they are morphologically different from sperm cells and may be ruled-out from being tracked on this basis. An example of an image including both spermatozoa and pipette is shown in FIG. 3; in this case the morphologically-distinct pipette may be eliminated from further consideration as described above.

Another method for elimination of objects is according to their estimated average velocity, i.e. if this velocity exceeds or falls below certain thresholds. Again this is in order to prevent “wasting” expensive computational resources on irrelevant objects. For example, a pipette may be (manually) moved by the operator, at a speed that much exceed the maximum speed of a sperm cell, in which case, this could be used as an indication of a non-relevant target.

Adaptive noise-reduction thresholding (e.g. using CFAR—“constant false alarm rate”—methodology) and global vibration cancellations may also be employed, using the following steps:
1. Performing spatial (i.e. grid) calculation of the statistics of “noise” within each grid area,
2. Defining a “low pass filter” criteria, which determines the accumulation of historic values, per pixel, so as to increase the sensitivity of the detection mechanisms, in case of low “duty cycle” of motion.
3. Defining a “threshold percentile”, exceeding which, will be considered as threshold crossing
4. Defining an N/M “persistence criteria” such that only pixels which exceeded the “threshold percentile” value in their respective grid, will be considered as being “persistent” targets, as opposed to spurious noise.

All of these methods may be enhanced by the previously mentioned methods of background subtraction, such as use of the median image as an indicator of static background to be removed.

### Brightness Calibration

A step of calibration may be performed early in the process (for example before or after registration/background removal) to remove effects of variable lighting. Fluorescent, LED, or other ambient lighting leaking into the images for instance may have periodic peak-and-valley effects, also known as a “beating” phenomenon, which will cause certain frames to be brighter and others lower; power-supply variations in the microscope illumination may likewise produce such effects. To deal with this situation, a step of automatic luminosity equalization may be carried out, where for instance a ‘reference frame’ is calculated as an average (possibly a moving average, slowly changing over time) over many frames, and subsequent frames' luminosity (or brightness, contrast, histogram, white balance, entropy, or other parameter) is adjusted to match the ‘reference frame’. The goal of such automatic calibration is to equalize the luminosity differences between incoming frames before combining them in subsequent steps. Similarly, automatic detection and removal of hot pixels and dead columns may be carried out to remove effects of CCD defects.

### Increased Number of Images

To obtain a larger number of frames with minimal movement in the observed images, the camera framerate may be operated as high as possible, for example in the “burst-mode” available on some cameras, or by use of a particularly high frame-rate camera. As will be appreciated the higher frame rate itself may come with a tradeoff of greater noise unless the system makes use of larger aperture and/or brighter illumination to achieve the same image brightness as would be achieved at lower framerate.

Secondly, if color information is not of interest (and in the case of motion tracking for spermatozoa this color information indeed may be redundant) then each of the R,G,B planes of a given color image may be used separately as an intensity image, to provide three images for every frame acquired. Such an approach may allow the increase of SNR in the target image.

### Combining Images

Now that we have a set or ‘stack’-ed set of registered, calibrated images, various means for combining these images may be employed.

### Averaging

A first method for superpixel resolution uses averaging of the set of images to achieve superpixel resolution. This is the simplest method and uses the mean of all the pixels in the stack, computed for each pixel.

### Median

A second method employs the median (as may also be useful for background subtraction). This method uses the median value of the pixels in the set, computed for each pixel of the image.

### Maximum

In this method the maximum value of all the pixels in the stack is computed for each pixel. This may be useful for debugging purposes, to exhibit all the defects of all the calibrated images.

### Kappa-Sigma Clipping

This method is used to reject deviant pixels iteratively, and makes use of two parameters: the number of iterations and a standard deviation multiplier (Kappa).

For each iteration, the mean and standard deviation (Sigma) of the pixels in the stack are computed. Each pixel having a farthest value from the mean more than Kappa * Sigma is rejected. The mean of the remaining pixels in the stack is computed for each pixel.

### Median Kappa-Sigma Clipping

This method is similar to the Kappa-Sigma Clipping method but instead of rejecting the outlying pixel values, they are replaced by the median value.

### Auto Adaptive Weighted Average

This method computes a robust average obtained by iteratively weighting each pixel in terms of its deviation from the mean, as a fraction of the standard deviation (see The Techniques of Least Squares and Stellar Photometry with CCDs—Peter B. Stetson 1989).

### Entropy Weighted Average (High Dynamic Range)

This method is based on the work of German, Jenkin and Lesperance (see Entropy-Based image merging—2005) and is used to stack a set of images into a final picture while keeping for each pixel the best dynamic range.

Another method for achieving super-resolution is using bursts of CFA raw images with small offsets. As described in Handheld Multi-Frame Super-Resolution (https://arxiv.org/abs/1905.03277) these frames are then aligned and merged to form a single image with red, green, and blue values at every pixel site, serving to both increase image resolution and boost signal to noise ratio.

The new image resulting from any of the above methods may be implemented as a higher bit-depth image of the same resolution (for instance by adding instead of averaging), or may have the same bit-depth but with lower noise due to averaging, or may have a higher spatial resolution with the same bit-depth.

By use of such superpixel methods as listed above, the method may address situations in which (for instance) the typical location differences of a sperm cell, from frame-to-frame is, e.g. 0.3 pixels (in the original, un-enhanced images) such that on average over 60% of ‘naïve’ frames would not indicate any motion. Nonetheless, assuming the motion-detection process subtracts a “moving-tail” of 10 recent frames, in that case, even an average motion of ˜0.1 pixel per frame, may be identifiable.

### Movement Parametrization

The invention provides for modeling the movement of motile sperm by fitting a curve based upon a number of movement parameters to the observed motion. This latter allows for a better characterization of the sperm movement, by introducing quantitative measures of linearity and curvilinearity and ‘higher order’ movement, as will be discussed in the detailed description. These methods may allow for both estimating trajectory parameters as well as addressing sperm-cell “collisions” via motion characterization.

In one approach, the best estimator from amongst a few estimators over a few motion models may be chosen. The notion of ‘best’ here may for instance be quantified by a using a cost-function over the estimation error of each particular fitting model, e.g. such cost-function may use an average r.m.s distance between the fit position and the observed position over a certain number of frames or over a certain time frame.

### Motion Estimators

Kalman filtering may be used as a motion estimator. The position to be estimated may for instance be the center of the sperm cell head. This position may be forward-extrapolated based on a polynomial curve fitting, sinusoidal curve fitting or any other suitable function fit to the observed motion. The polynomial or other estimator may be computed by use of linear and rotational velocities and accelerations, as well as slalom-like trajectories. Alternatively the motion of the sperm may be modelled as sinusoidal, cardioid, n-th order polynomial, or the like. Whatever the type of motion being used for modelling, the parameters of this motion may be estimated using a Kalman filter to estimate the subsequent or previous locations of the sperm cell.

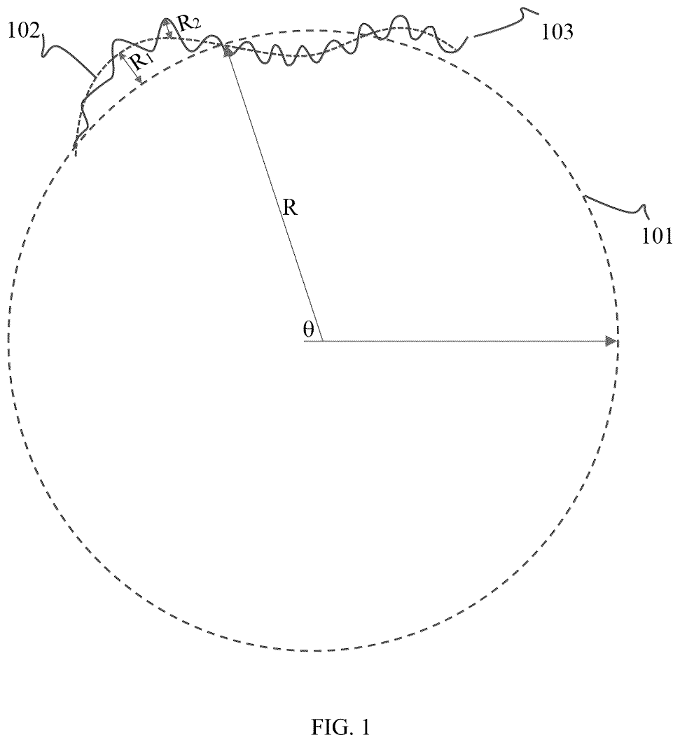

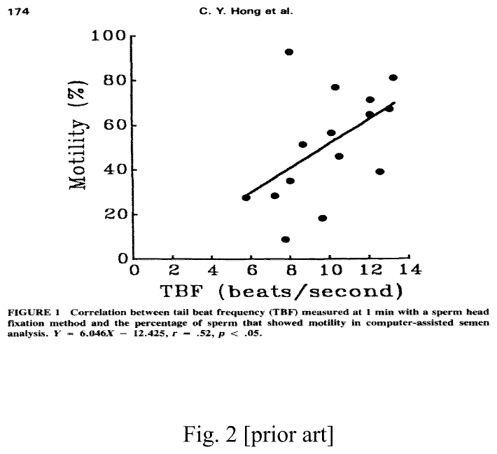

The model shown in FIG. 1 shows three types of trajectories, overlaid one on top of the other. The coarsest trajectory 101 is circular, and has a radius of R₀, angular rate of ω₀ and starting angle of θ₀.

The intermediate trajectory 102 is sinusoidal, which is superimposed over the aforementioned 0th order circular motion, and has an amplitude of R₁, angular rate of ω₁ and starting angle of θ₁.

The finest trajectory 103 is also sinusoidal, which is superimposed over the abovementioned 0th and 1st order trajectories, and has an amplitude of R₂ (in the image it is shown as “B”), angular rate of ω2 and starting angle of θ2.

In general, the polar representation of the location of an individual sperm cell, may be approximated by the following equation:

$$R ( t ) = {R}_{0} + {R}_{1} * sin ( {ω}_{1} * t + {θ}_{1} ) + {R}_{2} * Sin ( {ω}_{2} * t + {θ}_{2} )$$

$$θ ( t ) = θ ( t ) + {ω}_{0} * t$$

Kalman filtering over at least 3rd degree-of-freedom (i.e. location, velocity, acceleration, derivative of acceleration) may be used to estimate various parameters, such as R₀, R₁, R₂, θ₀, θ₁, θ₂, ω₀, ω₁, ω₂ in the parametrization above, or R₀, V and a in the parametrization

$$R ( t ) = {R}_{0} + V * t + 1 / 2 {a}_{2} * t$$

Once the motion has been fitted, a motility function can be calculated from the fitted motion parameters. For example for the circle-and-sin parameterization, a motility function could be

$$M = A / {R}_{0} + B \vert {R}_{1 , THRESH} - {R}_{1} \vert + C \vert {ω}_{1 , THRESH} - {ω}_{1} \vert + D \vert {R}_{2 , THRESH} - {R}_{2} \vert + E \vert {ω}_{2 , THRESH} - {ω}_{2} \vert$$

And similarly for the second velocity-and-acceleration parametrization,

$$M = A / {R}_{0} + B \vert {V}_{THRESH} - V \vert + C \vert {a}_{THRESH} - a \vert$$

may serve as a motility function. In both these cases, the motility function as defined here is better (describes healthier sperm) for lower values of M. Alternatively a motility function can be defined that increases for healthier sperm, either bounded or unbounded. Furthermore, it is within provision of the invention to use a multi-valued motility function. For instance the two values

$${M}_{R} = A / {R}_{0} + B \vert {R}_{1 , THRESH} - {R}_{1} \vert + D \vert {R}_{2 , THRESH} - {R}_{2} \vert$$

$$and$$

$${M}_{ω} = C \vert {ω}_{1 , THRESH} - {ω}_{1} \vert + E \vert {ω}_{2 , THRESH} - {ω}_{2} \vert$$

can be computed to give different estimates of health for path curvature M_{R} and speed of motion M_{ω}.

### Overcoming Sperm “Collisions” (i.e. Sperm Trajectory Interception)

For purposes of tracking individual spermatozoa the method outlined above for via motion characterization via Kalman filtering, i.e. forward-feeding the location of each individual sperm cell head, based on various possible parametrizations. As mentioned these may include linear and rotational velocity and accelerations, as well as slalom-like or sinusoidal trajectories, and using a Kalman filter to forward-feed or estimate the subsequent location of the sperm cell to maintain tracking of individual sperm cell heads.

An alternative approach is to use a temporal neural net such as a recurrent neural net (RNN) adapted for purposes of motion prediction. The input to such an RNN may be a series of images, and the output the expected next frame or frames. Alternatively, the input may be a series of images and labels for each spermatozoa, and the output r a set of next expected positions for each labelled spermatozoa. More specific descriptions of these methods will be discussed below.

### Determination of Length Scale

Automatic scaling may be used by means of introducing a known spatial pattern, e.g. a grid or ruler. Also, it is possible to employ automatic scaling by, e.g. measuring an average sperm cells' tail length, which is known to be approx. 50 um, or by means of measuring standard objects introduced into the field of view such as pippetes of known shape and dimension. If the objective magnification and sample distance is known, the length scale may be calculated directly from this information. A further ‘natural ruler’ may also simply be the known average size of the spermatozoa itself—since this size is known (e.g. for a given population of donors or individual donor) the length scale may be determined to some level of precision based solely upon the size of the spermatozoa, with the accuracy of the length scale increasing with the number of spermatozoa visible.

### Pattern Recognition for TESA/TESE

Pattern recognition methodologies to identify non-motile sperm cells in a TESE/TESA tissue sample are now discussed. Identification of viable, yet stationary, sperm-cells in a TESE/TESA tissue sample, may be accomplished using the sperm tail-beating pattern. Often, sperm cells in TESE/TESA tissue sample move their tails, yet are not seen to be swimming, because they may be entrapped in tissue debris, or are simply not energetic enough. Applying a temporal Fourier transform on the individual pixels, or alternatively in individual spatial-cells in a grid in the FOV (e.g. a 10×10 or a 50×50 grid), may be used to identify regions with substantial energy contents in the typical tail-beating-frequencies of sperm cells, e.g. in the 6-14 Hz frequency range. Existence of a supra-threshold (energy-wise) signal in particular spatial-cells in a grid of the FOV, could then be used by the system to provide the operator with visual cues to these particular spatial-cells, so that the operator may position the stage centered on these cells and transition the microscope to higher magnification, to examine whether there is a motile sperm cell disposed therein. It is within provision of the invention that this stage centering operation be performed automatically by means of a computer driven x-y (and possibly z-) stage. The tail-beating frequency of both motile and stationary cells may be determined by means of a motion parameterization such as that described above, adapted specifically for the purpose of tail-beating frequency, for instance by means of a preliminary step of subtracting the center-of-mass motion of the spermatozoa in order to obtain a stationary but still tail-beating specimen.

It is within provision of the invention to implement a scoring mechanism, to differentiate between sperm cells having different tail-beating frequencies, as a quality indication of each individual sperm cell. FIG. 2 for instance indicates a correlation between the beating frequency and motility.

Automatic detection of both moving, stationary tail-beating, and completely stationary sperm cells in images or videos may be accomplished by detecting sperm cells (or other types of cells or particles using a deep neural network (e.g., convolutional neural network, CNN). One implementation of the method is shown in FIG. 5.

This method may use any of the preprocessing steps described above, but even without such preprocessing the method described is adapted to work even in poor imaging conditions, such as those of low magnification, low resolution, variable lighting, noisy environments (as encountered in TESE/TESA samples), and so on.

During training, the neural network receives images of verified sperm cells (“labeled examples”) under the same imaging conditions, and the weights of the network are learned. As mentioned above these labeled examples, for training, can be obtained by manual labeling, or by automatic labeling. For example, use of classical computer vision tracking algorithms allows multiple frames of locations to be derived from a single initial frame. The motion subtraction algorithms mentioned above such as subtraction of the median image may further be used since in most samples, only the spermatozoa will be moving, and thus the only objects left after motion subtraction will be sperm cells which can be automatically labelled using (for example) classical computer vision morphological operations, and then manually checked.

An example of a training phase is shown in flowchart 610 of FIG. 5. Initial input 601 comprises images or video of swimming sperm cells, possibly in poor imaging conditions. Snice these seprmatazoa are swimming, automatic detection, tracking and tagging is easy to perform by means of a a conventional computer vision (CV) motion detector/tracker 602. The motion detection and tracking may comprise algorithms such as Dense Optical flow, which estimate the motion vector of every pixel in a video frame; sparse optical flow or the Kanade-Lucas-Tomashi (KLT) feature tracker, which track the location of a few feature points in an image; Kalman Filtering, which may be used to predict the location of a moving object based on prior motion information; Meanshift and Camshift, which locating the maxima of a density function; and any other object detector and tracker that may be of use in this context. Single object trackers may be combined to perform multiple object tracking with Re-Identification, as is the case with many of the algorithms listed above.

These detections produce tagged sperm-cell images or video 603 suitable for training a deep neural network 603 adapted for detection of spermatozoa. The detections may be verified by other means such as manual verification. Once a suitable amount of tagged images or video sequences are produced, they may be used to train a neural net 604, such as a deep convolutional neural network.

An inference phase is then possible after the training phase is complete. In inference, the network can automatically detect sperm cells, stationary or dynamic, on the imaged field of view, since it has learnt the features of the sperm cell images, in a variety of expected conditions (low magnification, low resolution, variable lighting and so on as mentioned above).

An example of an inference phase is shown in the flowchart 620 of FIG. 5. Here, untagged images or video sequences 605 (of the type used in the training steps of flowchart 610) are input into the trained deep neural network 606 produced previously. This network outputs inferences 607 indicating the locations of the stationary (or nonstationary) sperm cells. The output may be in terms of bounding boxes, pixel-level segmentation, or the like as determined by the nature of the training data.

Inference for any of the networks of the invention may be implemented in real time (e.g., by dedicated hardware).

This method is useful for cases of azoospermia, in TESE/TESA samples, where one needs to find sperm cells in low magnification (in order to see the entire sample), and there is a very low number of sperm cells, most of which do not swim. Furthermore there is often much debris in the imaged field of view. In this case, for training, we can take images of swimming sperm cells (which can be detected automatically) from another healthy sample (without azoospermia) in order to train the network, and then, during inference, detect all sperm cells in the azoospermia sample.

### Viscous Media Test

It is within provision of the invention to assess motion parameters that would have been measured in the same cell(s) in aqueous media, with a sperm sample disposed in a more viscous media by the following steps:
1. Obtaining threshold value(s) of velocity of a human sperm cell in aqueous medium, and indicating its motion quality score
2. Obtaining a viscosity-velocity curve for human sperm cells
3. Obtaining a concentration-viscosity relationship for particular sperm-cell suspension medium, e.g. PVP
4. Per an operator session, obtaining the particular type of IVF medium and its concentration (relative to water)
5. Per measured velocity of individual human sperm cell in said medium, apply the said concentration-viscosity and subsequently, viscosity-velocity transformation, so as to assess the instantaneous equivalent velocity of said human sperm cell in aqueous medium.
6. Compare the transformed velocity of individual sperm cell to said threshold value(s), so as to obtain said particular sperm cell's motion quality score.

In particular, the relationships between the sperm velocity in PVP (Polyvinylpyrrolidone) solutions of various commonly-used concentrations, and that of water, is provided by the following approximate relations:
V_who=V_pvp*1.9 for PVP 7%, or
V_who=V_pvp*2.4 for PVP 10% or
V_who=V_pvp for WATER

Where V_who is the velocity in water and V_pvp the velocity in various PVP solutions.

### Flow Chart

A flow chart of one exemplary embodiment is shown in FIG. 6 in simplified form. Optional steps are shown in boxes of dashed outline while necessary steps are shown in boxes of solid outline.

First an image sequence 501 is obtained. This input may comprise one or more images; in principle the pipeline can work image-by-image or sequence-by-sequence (as for example may be useful in conjunction with RNNs for tracking as described below. Other information may be found useful to include as input including system magnification and illumination, sample parameters such as temperature, pH, viscosity, PVP concentration, and the like; and possibly other information that may provide useful context for the subsequent analysis.

As mentioned above steps of sample-stage motion removal 502, registration 503, background removal 504, length-scale determination 505, brightness and camera calibration 506, and image combination for superpixel resolution 507 may now be optionally taken. The order of these operations is not necessarily as listed in this example and it may be found that different orders are more useful in different scenarios.

A step of spermatozoa detection 508 is now undertaken, ideally in an ‘instance aware’ fashion such that each spermatozoa is distinguished from the others and thus may be tracked from frame to frame. Movement parametrization 509 of individual and/or aggregate motion can now be undertaken in a number of ways as described above; generally speaking some a set of measures that relate to motility of individual spermatozoa are calculated. An optional step of non-motile sperm detection and parametrization 510 may now also be carried out (possibly using images that have not undergone background removal 504, which may tend to eliminate stationary parts of spermatozoa of interest).

The individual-spermatazoa calculations obtained may now be combined into sample-level calculations 511, for example including overall ratings of samples in terms of number of motile sperm per cc or cm\hat{ }2 or averages of motility measures, or more detailed information such as histograms of population size vs. motility level or other measurements.

The measurements obtained from the sample may now be presented 512 to the user in some form, for example by means of a suitable GUI or other web interface, possibly administered remotely over a network. The sequence may now repeat upon obtaining a new image or image sequence 501. In some implementations, the sample-level calculation and presentation may be carried out only once every N iterations of the loop.

### Pattern Recognition for Detection, Tracking, Classification, and Regression—Supervised Learning

The aforementioned methods may be used in conjunction with machine learning, computer vision, and artificial intelligence in order to better determine various parameters of interest.

For instance the inventive systems and methods may use images or video that either have gone through preprocessing such as are described above, or are used directly. One method of the invention for detecting sperm cells (or other types of cells or particles) involves using deep neural networks (e.g., convolutional neural network, CNN) and/or recurrent neural networks (RNN) of various types for detection, tracking, regression, and classification. These methods can be adapted to work even in poor imaging condition, such as low magnification and resolution, by means of preprocessing as mentioned above in addition to training using images or video having such poor imaging conditions.

Analysis may be performed in terms of detection (e.g. generation of bounding boxes around each detected example or pixel-level segmentation), classification (e.g. good/medium/bad or motility level 1 to 5), regression (e.g. motility level on a scale from 1-100), tracking (determination of path over time, ideally in an ‘instance-aware’ implementation), and any other outputs of a neural network model.

A training phase is employed, during which, one or more neural networks receive images of verified sperm cells along with class labels and/or continuous variables such as velocity (“labeled examples”) under some set of imaging conditions, and the weights of the network are learned. Training will be carried out using labelled examples of the desired type of output.

The training may be accomplished by means of backpropagation of errors to gradually change the weights of the neural network in a direction tending to minimize a loss function, which may be implemented using cross entropy (for class labels), mean squared differences (for continuous variables), or the like. The loss may be calculated over small batches using the so-called stochastic approach, to speed up learning by avoiding having to use the entire training cohort for each training step.

Labeled examples for use in a supervised learning scenario can be obtained by manual labeling, or by means of automatic or semi-automatic labeling. For example, given a video of motile sperm cells having no other motile elements (an ‘easy to detect’ sample), the moving elements may be detected using such methods as background subtraction or classical computer-vision-based motion detection, leaving the motile sperm cells which may be and used as training examples. The tagging may be accomplished in terms of bounding box, pixel-level segmentation, or other means. Bootstrap tagging, where a few training examples are used to produce a network with low accuracy that is used to tag more images that are then corrected and used to train a somewhat better network, whose output is used for training a third generation and so on, may also be used in this context.

Methodologies to (automatically) generate images of sperm cells for training deep-learning networks may be used for further training of neural network classifiers. These methods include using parametric 3D models, use of Generative Adversarial Models based on sets of real of 3D modelled images, and use of any other methodology as may be deemed useful.

After the training phase is complete, the network may be used to perform inference for automatic detection, classification, and parameter estimation (regression) of sperm cells in stationary or dynamic contexts. Insofar as training data in suboptimal conditions (of poor resolution, lighting, jitter, etc.) is provided, the inference (trained network running) may also be expected to successfully handle such images or video in similar conditions.

Inference of the network may be implemented in real time (e.g., by dedicated hardware) or offline, possibly occurring over an online connection (whereby for instance images/video are sent to a server, analyzed, and the results sent back to the user, for instance by means of an application programming interface (API) that defines a protocol for requesting and receiving such inferences). It is also within provision of the present invention to propose a hybrid mode of operation, wherein, within the scope of so-called “operational” mode of such system, the operator may indicate to the system where he/she identifies a suspected sperm cell, in which case, the system would add it to its training set, either locally, i.e., in a manner that would effect only that particular operator, or on a workstation-base, i.e. that particular system, or, on a site-base, i.e. for the plurality of such systems that are disposed in a given lab, and, lastly, globally, i.e., so that all similar systems are similarly updated.

Tracking may be accomplished by several means: the simplest involves use of systems as described above, adapted for still frame localization. More sophisticated approaches make use of convolutional neural networks adapted to take multiple frames as input, and/or convolutional nets in conjunction with recurrent neural networks (RNNs). Either of these approaches allow the system to deal with video for purposes of tracking. The tracking is ideally done in instance-aware fashion such that a given spermatozoon is followed, even in cases of obstruction, interference and overlap. Training in the case of video can be done using tagged or annotated video sequences, which themselves can be semi-automatically produced using still frame identification/localization means as described above, along with instance tagging which also may be automatic in most cases with (for example) human correction in the case of obstruction, interference or overlap.

Networks capable of dealing with image sequences can now be used to measure dynamic characteristics of spermatozoa, either in terms of classification (giving ‘class-level’ output such as no-motility, low-motility, normal motility, and high motility) or in terms of regression (giving a continuous score of motility e.g. in arbitrary units or units of velocity, or measurement of physical characteristics such as power output, morphology, or beat frequency). For the latter case of measuring motility, velocity, or other dynamic characteristics, the output of still-frame localization methods as described above may also be used in conjunction with knowledge of the time difference between frames (and possible sample stage movement) to calculate velocities or other motility parameters as well. Further motility parameters that may be of interest include straightness-of-path, swimming efficiency, forward velocity as compared to ‘wiggling’ velocity, velocity in various media and as a function of chemical or other (e.g. temperature or pressure) gradients, and so on. It is within provision of the invention to provide output in terms of any static or dynamic parameter of spermatozoa behavior and morphology.

Similar classification can be done regarding the morphology of the cells; for instance classifying into ‘ideal’, ‘fair’, ‘poor’ and ‘abnormal’ groups. Combined classifications/regressions with several outputs are also within provision of the invention, with for instance a single network being trained to give output both in terms of morphological class and velocity.

### Unsupervised Approaches

It is within provision of the invention to also make use of unsupervised approaches of machine learning for purposes of clustering or determining efficient latent representations, which may in turn be used for classification. For instance, an autoencoder or another method for unsupervised feature learning may be used. In the case of an autoencoder, convolutional layers may be used to reduce the information content of input images or video sequences of spermatozoa down to a bottleneck from which the network attempts to reproduce the original input. The point of this exercise is that the ‘bottleneck layer’ now contains a compact or ‘latent space’ representation of the input, which can then be used to compare various inputs and show clusters of like input which may more faithfully reflect the actual situation than a set of more-or-less arbitrary classes that are then hand-annotated or otherwise decided by human fiat.

For example, if an autoencoder trained on stationary images or video sequences of spermatozoa, after training it may be found that images of spermatozoa naturally cluster into three types, which on visual inspection appear to be a normal type and two different types of abnormal morphology or motility. Likewise, autoencoding of video sequences may reveal several distinct types of swimmers, a finding which may be of use both in clinical and research settings. Such networks, once produced, may be used for classification using cluster-based means such as measuring distances to cluster centers or similar means as will be clear to one skilled in the art. Similarly, the compact representation of such a network may be fine-tuned with annotated data in order to overcome situations of sparse training data.

### Specific Application—Azoospermia

In the case of azoospermia, there is a very low number of sperm cells (most of which do not swim). Therefore, large fields of view and low magnifications are generally used (to allow a potentially larger number of cells to be seen at once). Since in azoospemia, the biological sample is obtained via a semi-surgical testicular sperm extraction procedure called TESE or TESA—in which some volume of testicular tissue is being excised or aspirated and then turned into a cellular suspension, the result is that the majority of the non-fluid content of such sample is non-sperm cell and cellular debris, surrounding the sperm cells, which are in most cases, either non-motile, or, motile but stationary due to their entrapment in tissue debris.

In this case, for supervised learning scenarios, we can take images of swimming sperm cells (which can be detected automatically by use of motion detection, as will be clear to one skilled in the art), for example from healthy samples in order to train the network. During inference, this trained network is then able to detect all sperm cells in the azoospermia sample since the network has learnt the morphology of sperm cells, even under bad imaging conditions.

### Further Methods

Here we describe a method for automatic detection and classification of sperm cells based on both conventional and hidden features detected by a neural network. These features can be extracted from stationary images (morphological features) and/or videos (dynamic features).

During training, the deep neural network uses training images (or video) of sperm cells with labels (e.g. ‘normal’ vs. ‘abnormal’ or the like, and/or continuous variables for regression) and learns the features that characterize these inputs by calibrating the network weights.

For training, this labeling can either be created manually (e.g. using the acumen of one or more embryologists), by video object-motion-detection methods, by imaging sperm cells that passed sperm-enrichment assays (such as swim-up assays, microfluidic assays, DNA-fragmentation assays, hyaluronic-acid binding assays), or even by collecting sperm cells that reached the ovum area naturally in the female body as thus can be assumed as ‘good’ sperm cells. As mentioned above, classification is only one possibility, with for instance regression being another possible approach for the network output (in which case the input will be images labelled not with class labels but one or more continuous values such as sperm quality on a scale, swimming velocity, or the like).

The network encodes each sperm cell into a latent-space vector that represent all the features (conventional and hidden) of the inspected sperm, for example by means of an autoencoder that has undergone suitable training.

During inference, the network receives new sperm cell images or video and gives the appropriate output (for example classifies them, or in the case of a network trained for regression, gives one or more continuous outputs).

Differences between sperm cells can now be quantified by the mathematical distance between their latent-space vectors. The latent space may for instance be the penultimate layer of the neural network, before the regression or class labelling layer.

This process can be used to automatically grade the quality of a sperm cell, and also automatically detect a sperm cell in an image or a video and differentiate it from debris.

In order to check what the specific features detected by the network for good cells are, we can use a generative network, which takes the latent-space vector and uses it ‘backward’ to generate an image of a good sperm cell. Then by changing values in the latent-space vector, we can check visually what the features that change in the generated image are.

This may bring to new standardization in sperm-image and video analysis, indicating what the most important stationary and dynamic features for sperm analysis are. A similar method is to find the highest correlations between latent space elements and the network output.

### Overcoming Sperm “Collisions” (i.e. Sperm Trajectory Interception)

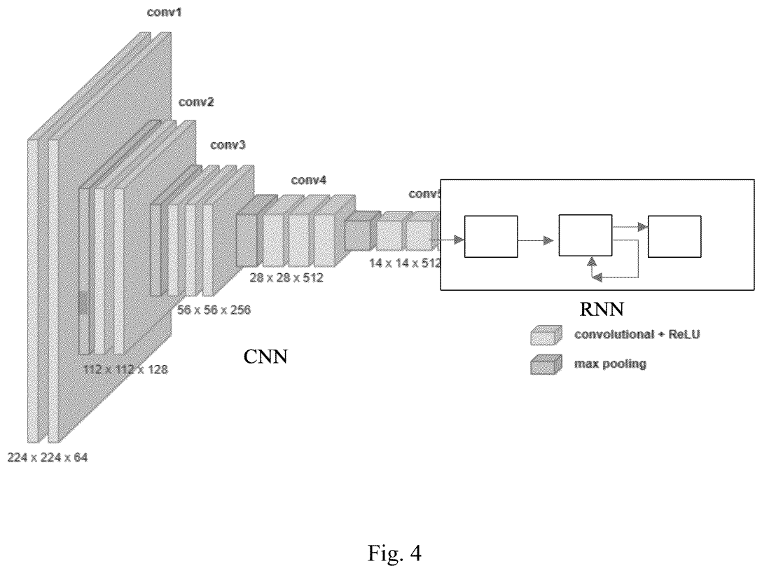

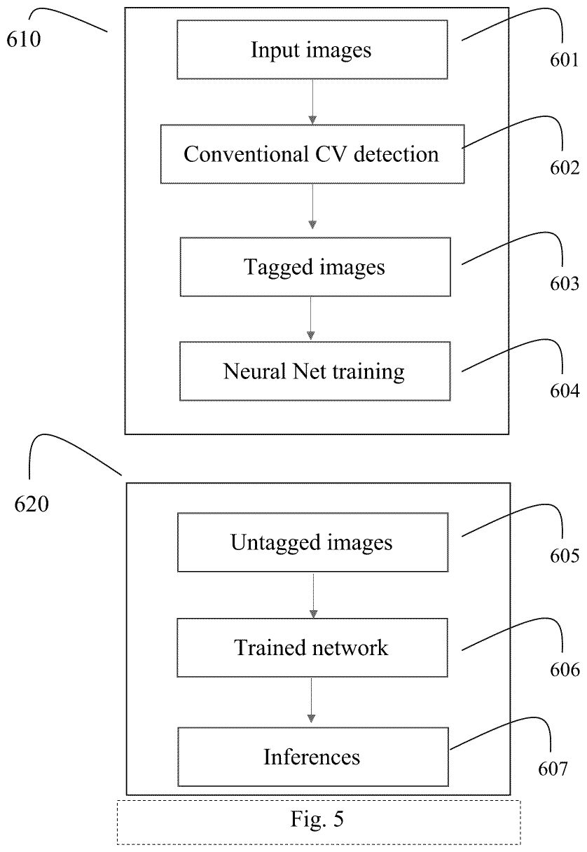

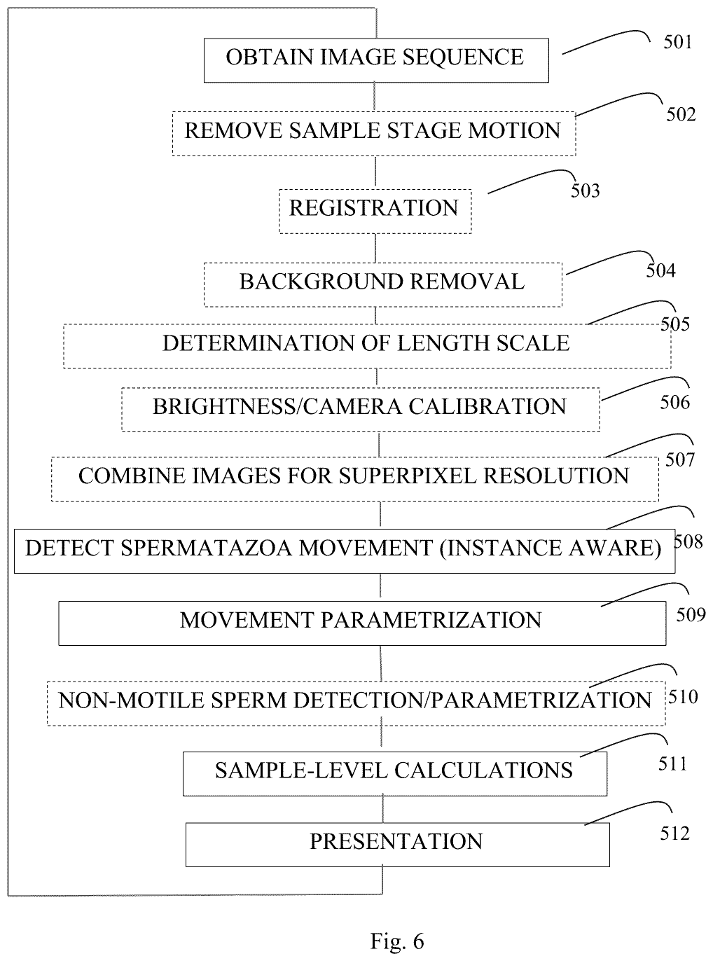

As mentioned, one approach that allows for instance-aware tracking (which largely overcomes common problems of tracking such as occlusion) is to use a temporal neural net such as a recurrent neural net (RNN) adapted for purposes of motion prediction. The input to such an RNN (or LSTM, GRU, or other network adapted for such purposes) may be a series of images, and the output the position of the set of (uniquely identified) detection objects on each frame. This input may pass through a preliminary CNN stage, as shown in FIG. 4. An alternative input may be a series of images and labels (e.g. instance labels, class labels, and/or continuous variable measures for regression) for each spermatozoon, and the output a set of next expected positions and labels for each labelled spermatozoon. Another possibility is to give output in terms of predicted motion vectors, with each sperm cell being detected and assigned an expected motion vector by the network. This motion vector may be (for instance) the vector tending to produce the expected position in the next frame of a video sequence. Higher-order motions can also be extracted from such networks, with (for instance) position, velocity, and acceleration outputs for each instance detection. In the case that the sperm cell motion is parametrized (for instance by taking into account the roughly sinusoidal shape of the cell's position over time, as produced by a healthy sperm cell's swimming motion) the network can be trained to output the coefficients of such a parametrization.

The foregoing description and illustrations of the embodiments of the invention has been presented for the purposes of illustration. It is not intended to be exhaustive or to limit the invention to the above description in any form.

Any term that has been defined above and used in the claims should be interpreted according to this definition.

The reference numbers in the claims are not a part of the claims, but rather used for facilitating the reading thereof. These reference numbers should not be interpreted as limiting the claims in any form.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

1. A method for determination of sperm motility consisting of the steps:
a. capturing a sequence of images of a sperm sample;
b. tracking the positions of each sperm in said images;
c. fitting a function to said track for each said sperm;
d. calculating one or more motility functions based upon said function;
whereby one or more quantitative mobility parameters are measured objectively.

2. The method of claim 1 where said step of capturing a sequence of images is accomplished by means of a video camera observing a field of view through a microscope.

3. The method of claim 1 wherein said step of tracking position is performed using subpixel location accuracy.

4. The method of claim 1 using convolutional neural networks to perform said tracking.

5. The method of claim 4 further using recurrent neural networks to perform said tracking.

6. The method of claim 4, training said neural networks with artificial data generated by means selected from the group consisting of: GAN, 2D model, 3D model.

7. The method of claim 3 using median image subtraction to perform said tracking.

8. The method of claim 1 wherein said fitting function is the set of equations
$$R ( t ) = {R}_{0} + {R}_{1} * sin ( {ω}_{1} * t + {θ}_{1} ) + {R}_{2} * Sin ( {ω}_{2} * t + {θ}_{2} ) . ;$$
$$θ ( t ) = θ ( t ) + {ω}_{0} * t .$$

9. The method of claim 1 wherein said fitting function is R(t)=R₀+V*t+½a₂*t

10. The method of claim 4 wherein said motility function is defined by
$$M = A / {R}_{0} + B \vert {R}_{1 , THRESH} - {R}_{1} \vert + C \vert {ω}_{1 , THRESH} - {ω}_{1} \vert + D \vert {R}_{2 , THRESH} - {R}_{2} \vert ++ E \vert {ω}_{2 , THRESH} - {ω}_{2} \vert .$$

11. The method of claim 5 wherein said motility function is defined by
$$M = A / R 0 + B \vert VTHRESH - V \vert + C \vert aTHRESH - a \vert .$$

12. The method of claim 1 wherein said step of fitting is accomplished using a minimization method.

13. The method of claim 1 wherein said step of fitting is accomplished using a Kalman filter.

14. The method of claim 1 further eliminating the effects of sample stage motion by means selected from the group consisting of: using position encoders to determine said sample stage motion; using mean particle velocity to determine said sample stage motion; using a known, fixed pattern on said sample stage to determine said sample stage motion.

15. The method of claim 1 further estimating the velocity of said sperm in water by measuring the velocity of said sperm in a solution of Polyvinylpyrrolidone by means of the relation
V_who=k(c)*V_pvp
where V_who is the velocity of said sperm in water, V_pvp is the velocity of said sperm in said PVP solution, and k(c) is a constant depending upon the concentration of said Polyvinylpyrrolidone solution.

16. A method for analysis of spermatozoa consisting of the steps:
a. obtaining training data consisting of a set of labelled images or image sequences;
b. training a neural net using said labels, by means of backpropagation;
c. using said trained neural net to predict labels for incoming images.

17. The method of claim 16 where said neural net comprises a convolutional neural network fed into a recurrent neural network, and wherein said labeled image sequences comprise future instance labels and positions of spermatozoa head centroids.

18. The method of claim 16 wherein said step of obtaining training data comprises:
a. Obtaining video sequences including spermatozoa;
b. Performing an optional step of background removal;
c. Performing a step of motion detection producing bounding boxes around moving spermatazoa;
thereby producing training data for said neural net automatically, from video sequences.

19. (canceled)

20. (canceled)

21. (canceled)

22. (canceled)

23. (canceled)

24. (canceled)

25. The method of claim 16 wherein said step of obtaining training data is accomplished using a GAN to generate said training data.

26. A method for analysis of spermatozoa image sequences using unsupervised learning and a set of training data image sequences comprising the steps:
a. training an autoencoder having a bottleneck layer on said training data image sequences, the output of said bottleneck layer being useful as a latent representation of said image sequences;
b. identifying the clustering of said latent representation on said training data image sequences in terms of a discrete number of population clusters;
c. identifying said image sequences to be analyzed in terms of their membership in one or more of said clusters.

27. (canceled)

28. (canceled)

29. (canceled)
